(19) United States
(12) Patent Application Publication
(10) Pub. No.: US 2008/0178213 A1
(43) Pub. Date: Jul. 24, 2008

(54) Method and Apparatus for An Interactive Display System

(76) Inventors: Alexander Knaani, Boca Raton, FL (US); Gopal Sarma Pingali, Mohegan Lake, NY (US)

Correspondence Address: F. CHAU & ASSOCIATES, LLC, 130 WOODBURY ROAD, WOODBURY, NY, 11797, US

(21) Appl. No.: 11/624,514

(22) Filed: Jan. 18, 2007

(51) Int. Cl. G06K 9/00; H04N 7/18

(52) U.S. Cl. 725/37; 340/933

(57) ABSTRACT

A computer-implemented method for interacting with a computer-system includes detecting a display surface entering an area serviced by the computer-system, projecting a video interface onto the display surface, capturing a video stream of the display surface and video interface, performing a motion analysis on the video stream to detect an interaction with video interface projected on the display surface, processing the interaction to determine a display zone at a location of the interaction on the display surface, and performing an action based on the display zone at the interaction point.

### BACKGROUND OF THE INVENTION

1. Technical Field

The present disclosure relates to customer service, and more particularly to a system and method for an interactive display system.

2. Description of Related Art

It is advantageous in many retail and other applications involving a transaction between a business and its customers to enable interaction with the customers while they are in their automobile. Examples include drive-through areas in restaurants, financial institutions in the form of automatic teller machines and teller windows, parking lots of shopping malls, etc. In the case of a drive-through in a fast food restaurant, interaction between the customer and the restaurant typically takes place through a voice dialog. This can be limiting both to the customer and to the retailer. From the retailer's point of view, there are several challenges including the need for an employee involved in the voice transaction, communication gaps and delays due to lack of understanding between the employee and the customer (e.g., deciphering accents, bad sound quality, etc.), difficulty in dynamically changing the offers to the customer including up selling and cross selling, and creating a shopping experience that is easy and fun.

Therefore, a need exists for system and method for an interactive display system.

### SUMMARY OF THE INVENTION

According to an embodiment of the present disclosure, a computer-implemented method for interacting with a computer transaction-system includes detecting a display surface on a vehicle entering an area serviced by the computer transaction-system, enabling an interactive interface on the display surface, processing the interaction, and performing a transaction based on an interaction.

According to an embodiment of the present disclosure, a program storage device is provided readable by machine, tangibly embodying a program of instructions executable by the machine to perform method steps for interacting with a computer transaction-system. The method steps include detecting a display surface entering an area serviced by the computer transaction-system, projecting a video interface onto the display surface, capturing a video stream of the display surface and video interface, performing a motion analysis on the video stream to detect an interaction with video interface projected on the display surface, processing the interaction to determine a display zone at a location of the interaction on the display surface, and performing an action based on the display zone at the interaction point.

According to an embodiment of the present disclosure, a computer-transaction system includes a video camera as a sensor for sensing an environment, a video projector as a display device in the environment for projecting an interface onto a display area, and a processor for processing interactive commands for performing a purchase transaction comprising, an image processor module for processing a video stream from the video camera and outputting a set of parameters comprising a set of object parameters and a set of interaction parameters, and a display controller module for processing the object parameters and the interaction parameters.

### BRIEF DESCRIPTION OF THE DRAWINGS

Preferred embodiments of the present invention will be described below in more detail, with reference to the accompanying drawings:

FIG. 1 is a diagram of a retail cycle;

FIG. 2 is a flow chart of a method according to an embodiment of the present disclosure;

FIG. 3 is a diagram of an interactive display system system according to an embodiment of the present disclosure;

FIG. 4 is a flow chart of a method for implementing an interaction display according to an embodiment of the present disclosure; and

FIG. 5 is a diagram of a computer-system according to an embodiment of the present disclosure.

### DETAILED DESCRIPTION OF PREFERRED EMBODIMENTS

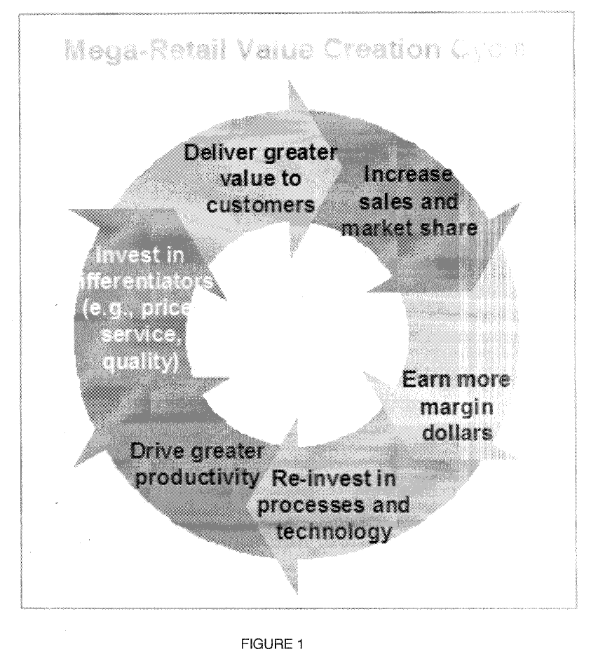

A mega-retail value creation cycle (see FIG. 1) includes three areas where retailers can improve, including increased revenue, cost reduction, and asset reutilization.

According to an embodiment of the present disclosure, the mega-retail value creation cycle is improved through the utilization of a display, such as a vehicle's windshield, as an interactive display to perform retail transactions. As such, the display may be a heads-up type display. When the customer is within a defined retail environment in their automobile, the retailer may display information on to the customer's display system enabling direct interaction with the customer, which in turn allows for transactions. The display may facilitate transactions at drive-thru locations, gas stations, shopping mall parking lots, highway and truck rest areas, etc.

Implementation of transactions via a display can affect a cost structure reduction as the customer directly performs the transaction without needing to interact with a retail employee, improved consumer experience with dynamic displays, clear communication, reduced delays etc., easy and dynamic offers for cross and up-sell opportunities, and increases reach and ubiquity of the retailer.

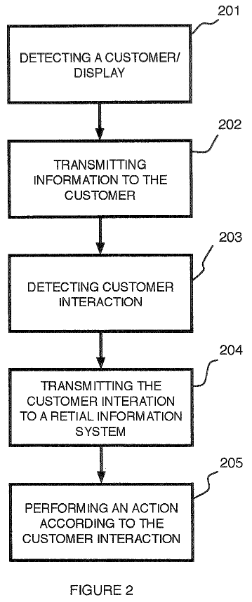

According to an embodiment of the present disclosure, referring to FIG. 2, a method includes detecting the presence of a display within a defined premises/area relevant to a retailer 201, transmitting an information display on to the windshield of the automobile 202, sensing customer interactions with the display on the windshield 203, transmitting the customer interactions to a retail information system 204, and performing actions such as placing an order, conveying a message, changing the display etc. based on the customer transaction 205.

Detecting the presence of a display may be performed through a combination of a pressure sensor and a camera based vision system that determines the presence of a car and the location and orientation of the windshield. The transmission of information may include projection of the information on to a windshield by means of an external projector. Other embodiments include having a microfilm-based display with an embedded wireless transmitter. For sensing user interaction, a camera can be used to sense the interactions through processing the video image from the camera; other embodiments include a touch sensitive display with an embedded transmitter.

In effect, the display of information in an automobile enables the creation of a transactional/marketing display, transforming the display into a “temporary” touch screen. By doing so, car passenger/s will be able to obtain information and also to perform a transaction while they are in the car. To address safety concerns, the system will not function while the car is in motion.

Markets may include automotive accessories such as windshield films, microelectronics such as microchips embedded into the windshield film, and financial services as an extension to credit cards.

In new retail solutions for reaching customers in their automobiles, in projection systems that project on to an automobile windshield, in microfilms that can be attached to automobile windshields.

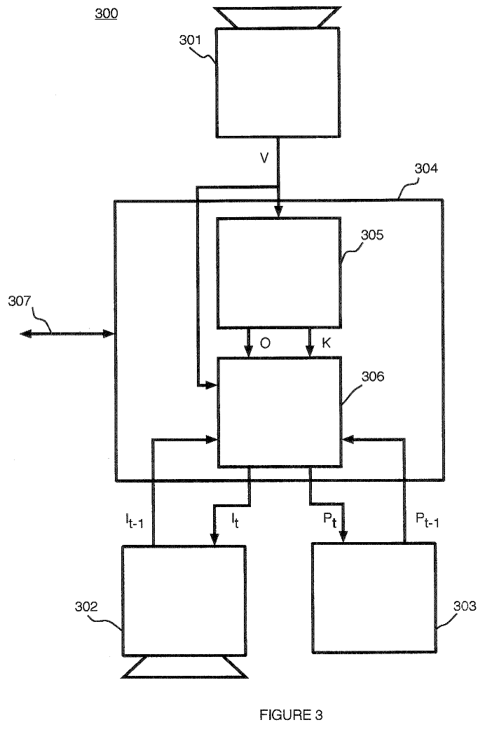

An exemplary embodiment of a system of the present disclosure is illustrated in FIG. 3. The system 300 comprises a video camera 301 as a sensor for sensing the environment, a video projector 302 as a display device in the environment, a redirection device 303, e.g., a pan-tilt head, for moving the video projector 302, thus making the projector 302 a moveable projector, and a computer processor 304 that contains the processing modules and codes needed to realize the interactive system.

The computer 304 implements transaction software for interacting with a client. The computer 304 may pass transaction information across a network 307 to another computer (not shown) connected to the network for implementing the transaction software for interacting with the client. Further, additional hardware such as a security system, for example, for monitoring clients via a captured video stream, or a database, for example, for storing information about available products, may be connected to the network 307 and accessible to the computer 304.

The computer 304 includes an image processor module 305 that processes the sequence of images V coming from the camera 301, and outputs a set of parameters comprising a set of object parameters O and a set of interaction parameters K. Examples of sensed interactions by the camera include presence of a person in an aisle, the act of picking up a product, or a hand touching the image displayed by the projector. The parameters and the image sequence are processed by a display controller module 306 of the computer 304.

The display controller 306 also receives the parameters that include the image I displayed by the projector 302, and the parameters P of the redirection device 303 corresponding to the previous time instance t−1. The parameters P can include the pan value, tilt value, pan and tilt speeds, current position and orientation, focus and zoom of the projector, and image distortion parameters. Based on the sensed interactions K, the display controller 306 determines a new image to be displayed by the projector 302 at the current time instance t, as well as the new redirection parameters for the redirection device 303.

According to an embodiment of the present disclosure, the system 300 may be implemented as a single unit or implemented as a disjoint set of modules communicating via a wired and/or wireless network. For example, the projector/display device 302 may be implemented within a vehicle while the video camera 301 is separately controlled. In such an example, the redirection device 303 controls an orientation of the video camera 301 for capturing a view of an image projected by the projector 302. Thus, the video camera 301 may capture an image projected on the windshield of various vehicles having different heights, etc. The projector 302 may communicate with the computer 304 used any available wireless communications protocol for receiving the video to be displayed.

The redirection device 303 is optional, such as when the display surface can be appropriately positioned for display of the interface without needing an adjustment of an orientation of the video camera 301 or projection 302.

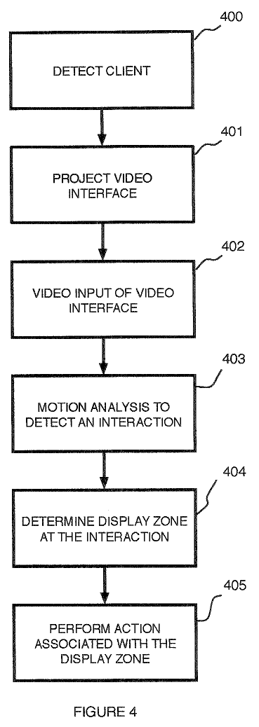

According to an exemplary embodiment of the present disclosure, FIG. 4 illustrates a method for sensing interactions and responding through displays in the interactive system depicted in FIG. 3. Upon a client entering an area serviced by the system 300, the client is detected 400, for example, using object detection system/method for detecting the presence and locations of objects in an environment, for example, a vehicle. The object detection system/method may be implemented using the video camera 301 and computer 304. A video interface is projected onto a display surface 401 such as a windshield or side window of the vehicle. The redirection device 303 may adjust the orientation of the video camera 301 or projector 302 is needed according to a sensed location of the display surface. A video stream of the display surface is captured 402 by the video camera 301. A motion analysis is performed on the video input to detect an interaction with interface projected on the display surface. For example, an image differencing may be performed by computing a difference between a current image seen by the camera and a previous image seen by the camera, or the image differencing may include computing the difference between the image seen by the camera and the image projected by the projected. Each interaction is then processed to determine the available display zones near the location of the particular interaction 404. A display zone indicates that an area in which an image can be displayed. The determination 404 utilizes the currently available display device parameters. An action is performed based on the display zone at the interaction point, e.g., selecting a product to be purchased. The system/method may continuously monitor the interface until the client leaves the serviced area.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

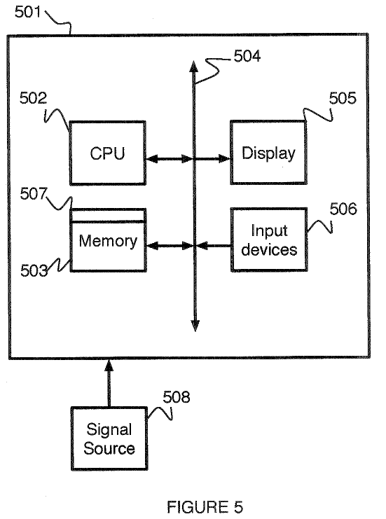

Referring to FIG. 5, according to an embodiment of the present disclosure, a computer system 501 for implementing an interactive display system comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. The present invention can be implemented as a routine 507 that is stored in memory 503 and executed by the CPU 502 to process the signal from the signal source 508. As such, the computer system 501 is a general-purpose computer system that becomes a specific purpose computer system when executing the routine 507 of the present invention.

The computer platform 501 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present disclosure provided herein, one of ordinary skill in the related art will be able to contemplate these and similar implementations or configurations.

Having described embodiments for a system and method for an interactive display system, it is noted that modifications and variations can be made by persons skilled in the art in light of the above teachings. It is therefore to be understood that changes may be made in embodiments of the present disclosure that are within the scope and spirit thereof.

What is claimed is:

1. A computer-implemented method for interacting with a computer transaction-system comprising:
detecting a display surface on a vehicle entering an area serviced by the computer transaction-system;
enabling an interactive interface on the display surface;
processing the interaction; and
performing a transaction based on an interaction.

2. The computer-implemented method of claim 1, wherein enabling the interactive interface comprises:
displaying a video interface on the display surface; and
capturing a video stream of the display surface and video interface.

3. The computer-implemented method of claim 1, wherein displaying comprises projecting.

4. The computer-implemented method of claim 1, wherein processing the interaction comprises:
performing a motion analysis on the video stream to detect an interaction with video interface projected on the display surface;
processing the interaction to determine a display zone at a location of the interaction on the display surface; and
performing the transaction based on the display zone at the interaction point.

5. The computer-implemented method of claim 1, further comprising:
detecting a location of the display surface; and
adjusting an orientation of a projector to display the video interface onto the display surface.

6. The computer-implemented method of claim 1, further comprising:
detecting a location of the display surface; and
adjusting an orientation of a video camera to capture the video stream of the display surface and video interface.

7. The computer-implemented method of claim 4, wherein the motion analysis includes an image differencing performed by the computer transaction-system for determining a difference between a current image seen by a camera and a previous image seen by the camera.

8. The computer-implemented method of claim 4, wherein the motion analysis includes an image differencing performed by the computer transaction-system for determining a difference between an image seen by a camera and an image projected by the projector.

9. The computer-implemented method of claim 1, wherein the transaction is a purchase transaction.

10. A program storage device readable by machine, tangibly embodying a program of instructions executable by the machine to perform method steps for interacting with a computer transaction-system, the method steps comprising:
detecting a display surface entering an area serviced by the computer transaction-system;
projecting a video interface onto the display surface;
capturing a video stream of the display surface and video interface;
performing a motion analysis on the video stream to detect an interaction with video interface projected on the display surface;
processing the interaction to determine a display zone at a location of the interaction on the display surface; and
performing an action based on the display zone at the interaction point.

11. The method of claim 10, further comprising:
detecting a location of the display surface; and
adjusting an orientation of a projector to display the video interface onto the display surface.

12. The method of claim 10, further comprising:
detecting a location of the display surface; and
adjusting an orientation of a video camera to capture the video stream of the display surface and video interface.

13. The method of claim 10, wherein the motion analysis includes an image differencing performed by the computer transaction-system for determining a difference between a current image seen by a camera and a previous image seen by the camera.

14. The method of claim 10, wherein the motion analysis includes an image differencing performed by the computer transaction-system for determining a difference between an image seen by a camera and an image projected by the projector.

15. A computer-transaction system comprising:
a video camera as a sensor for sensing an environment;
a video projector as a display device in the environment for projecting an interface onto a display area; and
a processor for processing interactive commands for performing a purchase transaction comprising,
an image processor module for processing a video stream from the video camera and outputting a set of parameters comprising a set of object parameters and a set of interaction parameters, and
a display controller module for processing the object parameters and the interaction parameters.

16. The system of claim 15, further comprising a redirection device for changing an orientation of the video camera according to the object parameters.

17. The system of claim 15, further comprising a redirection device for changing an orientation of the video projector according to the object parameters.

18. The system of claim 15, further comprising a network connected to the processor.

19. The system of claim 15, wherein the video projector communicates with the processor via a wireless network.

20. The system of claim 15, wherein the video camera communicates with the processor via a wireless network.
